(19) United States
(12) Patent Application Publication
(10) Pub. No.: US 2020/0017047 A1
(43) Pub. Date: Jan. 16, 2020

(54) MOLDED COMPONENT FOR VEHICLE

(71) Applicant: HONDA MOTOR CO., LTD., TOKYO (JP)

(72) Inventors: Masuo KONDO, Wako-shi, Saitama (JP); Takashi ADACHI, Wako-shi, Saitama (JP)

(21) Appl. No.: 16/456,643

(22) Filed: Jun. 28, 2019

(30) Foreign Application Priority Data
Jul. 10, 2018 (JP) 2018130679

(51) Int. Cl. B60R 19/52

(52) U.S. Cl. CPC B60R 19/52; B60R 2019/525

(57) ABSTRACT

A molded component for a vehicle such as a front grille (3) includes a molded plastic base member (10), a first coating layer (13) applied on a surface of the base member, and a second coating layer (14) applied on a surface of the first coating layer, the second coating layer (14) containing flakes of aluminum (20a) and flakes of a silicate compound (20b). The first coating layer has a brightness of 1 to 6.

### TECHNICAL FIELD

The present invention relates to a molded component for a vehicle.

### BACKGROUND ART

Lustrous paint is gaining popularity for coating automobile vehicle bodies. Typically, aluminum flakes, glass flakes and/or mica flakes are mixed in the paint as a part of the pigment for the paint to create a metallic, pearlescent or otherwise lustrous external appearance. Plastic exterior components of the vehicle are often coated with a same or similar paint so that the exterior of the vehicle may present a uniform appearance.

A radar device is often mounted to the vehicle body to allow an autonomous driving or to assist the vehicle operator to acquire information on the environment surrounding the vehicle. Oftentimes, a plastic exterior component is positioned in front of the radar device. In such a case, the plastic exterior component is required to be able to transmit the radio wave emitted from and received by the radar device with a minimum attenuation. However it is known that metallic paint applied to such a component attenuates the transmission of the radio wave to a certain extent owing to the aluminum or other metal content thereof. JP5237713B discloses a plastic component coated with a metallic paint that is intended to minimize attenuation of radio wave transmitted through the plastic component by controlling the orientation and distribution of aluminum flakes contained in the metallic paint, and using flakes of glass or pearl mica in addition.

However, if the content of glass or pearl mica flakes is increased while reducing the content of aluminum flakes in the hope of improving radio wave transmission, the surface of the component becomes whitish or transparent, and the distinction between highlight regions and shade regions on the surface of the component is reduced, resulting in the loss of the metallic appearance.

### SUMMARY OF THE INVENTION

In view of such a problem of the prior art, a primary object of the present invention is to provide a molded component for a vehicle which has a high transmissivity for radio wave, and presents a desirable metallic external appearance.

The present invention achieves such an object by providing a molded component for a vehicle, comprising: a molded plastic base member (10); a first coating layer (13) applied on a surface of the base member; and a second coating layer (14) applied on a surface of the first coating layer and containing flakes of aluminum (20a) and flakes of a silicate compound (20b); the first coating layer having a brightness of 1 to 6.

Thereby, metallic appearance can be achieved while ensuring a high radio wave transmissivity. When the incident light is impinged upon the surface of the molded component from a substantially orthogonal direction, the incident light is simply reflected by the aluminum flakes and the silicate compound flakes. Therefore, the surface of the molded component demonstrates a relatively high brightness. When the incident light is impinged upon the surface of the molded component from an oblique direction, the incident light is reflected multiple times by the aluminum flakes and the silicate compound flakes in the second coating layer. The light that is reflected by the second coating layer is absorbed by the first coating layer. Therefore, the surface of the molded component demonstrates a relatively low brightness. As a result, the surface of the molded component reflects light with highly contrasted intensity depending on the direction of the incident light, and this creates an enhanced metallic appearance. This effect is achieved even when the content of the silicate compound flakes is relatively high in relation to the content of the aluminum flakes so that the desired high radio wave transmissivity can be achieved at the same time.

Preferably, the first coating layer has a low brightness, and relatively dark so that the first coating layer may favorably absorb the light reflected multiple times by the second layer. Since the silicate compound flakes and the aluminum flakes are typically whitish or light in color, when the second coating layer is applied on the first coating layer which is relatively dark, a speckled appearance may be created owing to the presence of the silicate compound flakes and the aluminum flakes in the second layer. However, by selecting the brightness of the first coating layer to be 1 or higher, the silicate compound flakes and the aluminum flakes in the second layer are prevented from creating a speckled appearance. By selecting the brightness of the first coating layer to be 6 or lower, the surface of the molded component is prevented from having a whitish or pearl-like appearance, and is given with a proper metallic appearance.

Preferably, the flakes of the silicate compound essentially consist of flakes of mica coated with titanium oxide, and/or flakes of glass coated with titanium oxide.

The material for the silicate compound flakes may be selected from a wide range of silicate compounds, but is preferably selected from phyllosilicates and various forms of glass. For instance, the silicate compound flakes can be prepared with relative ease simply by crushing mica or thin glass. By coating the silicate compound with titanium oxide, the luminosity of the silicate compound can be enhanced, and the external appearance of the molded component can be enhanced.

Preferably, the second coating layer has a thickness of 10 μm to 30 μm and an aluminum content greater than 0% and less than or equal to 10% by weight.

By selecting the thickness of the second coating layer to be 10 μm or greater, the second coating layer acquires a favorable weathering property, and can be applied evenly on the surface of the base member. By selecting the thickness of the second coating layer to be 30 μm or less, when the light is obliquely incident on the surface of the base member, the first coating layer can effectively absorb light the light hat has been reflected multiple times by the silicate compound flakes and the aluminum flakes. By selecting the aluminum content to be greater than 0% by weight, a high luminosity can be ensured. By selecting the aluminum content to be 10% by weight or less, a high radio wave transmissivity can be ensured.

Preferably, an average particle diameter of the aluminum flakes is 1.0 μm to 30.0 μm.

Thereby, the aluminum flakes in the second coating layer can be oriented in parallel with the surface of the base member with relative ease so that the aluminum flakes are prevented from protruding from the surface of the second coating layer, and the diffuse reflection at the surface of the second coating layer can be minimized.

Preferably, the flakes of the silicate compound are oriented along the surface of the base member.

Thereby, the silicate compound flakes are prevented from protruding from the surface of the second coating layer, and the diffuse reflection at the surface of the second coating layer can be minimized.

Thus, the present invention provides a molded component for a vehicle which has a high transmissivity for radio wave, and presents a desirable metallic external appearance.

### BRIEF DESCRIPTION OF THE DRAWING(S)

FIG. 1 is a perspective view of a front part of a vehicle fitted with a molded component according to an embodiment of the present invention;

FIG. 2 is a microscopic sectional view of a surface part of the molded component;

FIG. 3a is a graph showing the relationship between the aluminum content and the radio wave transmissivity; and

FIG. 3b is a graph showing the relationship between the aluminum content and the surface luminosity.

### DESCRIPTION OF THE PREFERRED EMBODIMENT(S)

A molded component in the form or a front grille for a vehicle according to an embodiment of the present invention is described in the following with reference to the appended drawings.

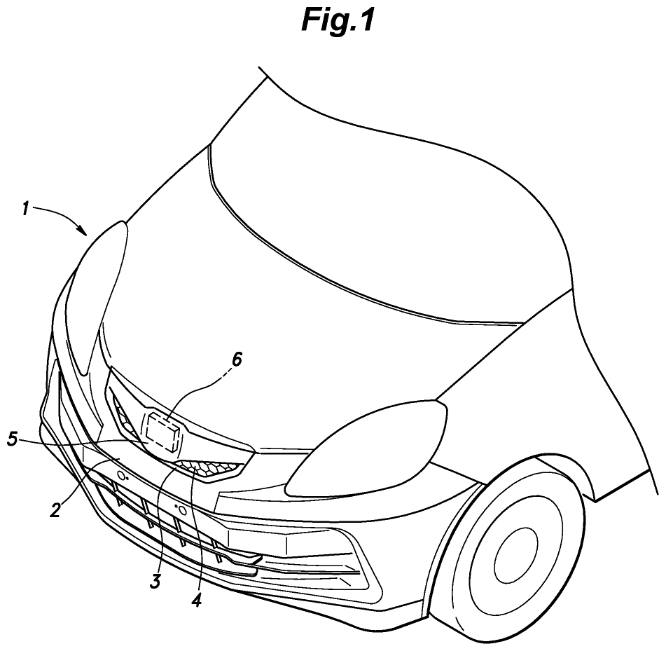

As shown in FIG. 1, a vehicle 1 such as an automobile is provided with a front bumper face 2 in a front part of the vehicle body, and a front grille 3 positioned above the front bumper face 2. A radiator, an engine and other components are placed in an engine room defined behind the front bumper face 2 and the front grille 3. The front grille 3 consists of a molded member made of plastic material such as polypropylene, and includes a grille main body 4 and an emblem part 5 attached to a laterally central part of the grille main body 4. The grille main body 4 is formed as a lattice work or is otherwise provided with a plurality of through holes to permit air flow into the engine room. A radar device 6 for emitting a 77 GHz electromagnetic radio wave (millimeter wave) is attached to a part of the vehicle body immediately behind the emblem part 5. The radar device 6 detects objects located ahead of the vehicle to assist an autonomous driving, or the operation of an automatic device of the vehicle such as an automatic emergency brake, or to allow the vehicle operator to acquire information on the environment surrounding the vehicle.

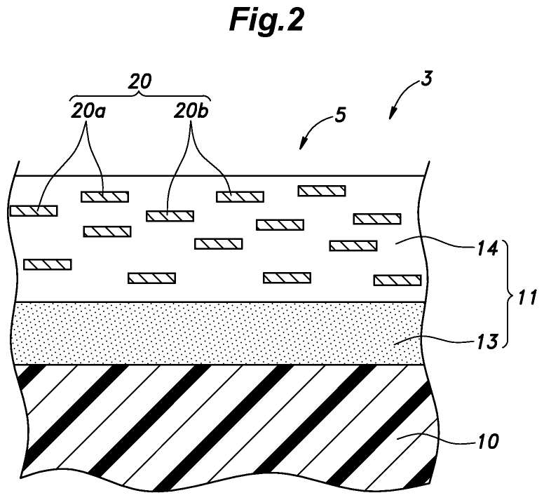

As shown in FIG. 2, the emblem part 5 includes a plate-like base member 10 having a major plane facing forward, and a lustrous coating 11 applied on the front surface of the base member 10.

The lustrous coating 11 includes two layers of paint applied one over the other on the surface of the base member 10. The lustrous coating 11 of the emblem part 5 on the base member 10 creates a lustrous appearance which may be referred to as pearlescent and metallic.

The lustrous coating 11 includes a first coating layer 13 applied on the surface of the base member 10 and a second coating layer 14 applied on the (outer) surface of the first coating layer 13. The lustrous coating 11 may be provided on the entire front surface of the base member 10 or a part of the front surface of the base member 10. The first coating layer 13 is formed by applying a paint having a brightness of 1 to 6 on the front surface of the base member 10. The brightness (meido) is based on the Japanese Industrial Standard JIS Z8721. The brightness ranges from the value of 10 corresponding to white color to the value of 0 corresponding to black color. The brightness is typically determined by using a color sample. In the present embodiment, the paint for the first coating layer 13 consisted of urethane paint having a brightness of 1 and generally black in color. The first coating layer 13 is formed by applying the paint for the first coating layer 13 to the front surface of the base member 10, and then being left at 80° C. for 20 minutes. The thickness of the first coating layer 13 is preferably 5 μm to 15 μm, more preferably 7 μm to 12 μm. In the present embodiment, the brightness of the first coating layer 13 was 1 and the thickness of the first coating layer 13 was 10 μm. Here, the thickness of the first coating layer 13 is measured by using a known electromagnetic film thickness meter after a predetermined time period (up to several hours) has elapsed since the paint for the first coating layer 13 is applied.

The second coating layer 14 is formed by coating a paint containing aluminum flakes 20a and silicate compound flakes 20b. The second coating layer 14 is formed by applying the paint on the front surface of the first coating layer 13. The thickness of the second coating layer 14 is preferably 10 μm to 30 μm, more preferably 15 μm to 25 μm. In the present embodiment, the thickness of the second coating layer 14 was 20 μm. The thickness of the second coating layer 14 was measured by using an electromagnetic film thickness meter after a predetermined time (up to several hours) has elapsed since the application of the paint for the second coating layer 14. The content of aluminum flakes 20a in the second coating layer 14 is preferably 5% to 10% by weight, and more preferably 6.5% to 8.5% by weight. In the present embodiment, the content of aluminum in the second coating layer 14 was 8% by weight. Here, the aluminum content of the second coating layer 14 is calculated according to the ratio of the weight of the contained aluminum to the weight of the entire paint excluding the volatile solvent therein.

The aluminum flakes 20a contained in the paint for the second coating layer 14 are formed by crushing aluminum foil into scaly flakes (small flat plate flakes). The average particle diameter of the aluminum flakes is preferably 1.0 μm to 30.0 μm, and in the present embodiment, the average particle diameter of the aluminum flakes was 10 μm. The average particle diameter (D50) means a median particle diameter or a cumulative 50% point of particle diameter in a particle distribution (a number of occurrences vs. particle diameter curve) obtained by using a laser diffraction measurement tool. In other words, the average particle diameter (D50) is the diameter of the particle that 50% of a sample's mass is smaller than and 50% of a sample's mass is larger than.

Preferably, the average thickness of the aluminum flakes 20a in the second coating layer 14 is preferably 5.0 μm or less, and in the present embodiment, the average thickness of the aluminum flakes was 1 μm. Here, the average thickness is determined by observing the cross section of the second coating layer 14 with a scanning electron microscope (SEM). In this embodiment, the thickness of randomly extracted 100 flakes was measured, and the numerical average was given as the average thickness. The shape of the major plane of each aluminum flake may be any of a circle, an ellipse, a polygon, or a bowl shape. The aluminum flakes 20a may be coated with titanium oxide or the like.

The silicate compound flakes 20b may consist of scaly mica flakes (small flat plate flakes). The silicate compound flakes 20b are formed by wet grinding or by stirring and grinding a mixture of water and mica (which may be naturally produced mica or synthetic mica). The average thickness of the silicate compound flakes 20b is preferably 0.5 μm to 5 μm, and in the present embodiment, the average thickness of the silicate compound flakes 20b was 1.0 μm. The average particle diameter of the silicate compound flakes 20b is preferably 20 μm to 80 μm, and in the present embodiment, the average particle diameter of the silicate compound flakes 20b was 40 μm. The average particle diameter and the average thickness of the silicate compound flakes 20b were both measured by the same method as the aluminum flakes 20a.

The silicate compound flakes 20b are each coated with titanium oxide on the outer surface. The average thickness of the titanium oxide coating on the silicate compound flakes 20b is preferably 40 nm to 60 nm, and in this embodiment, the average thickness of the titanium oxide coating was 50 nm. For example, titanium oxide coating may be applied on the outer surface of the silicate compound flakes 20b by plating, CVD, vapor deposition, or the like. In the present embodiment, the titanium oxide coating was applied by CVD, and the thickness of titanium oxide coating was measured by using a commercially available film thickness meter at the time of applying the titanium oxide coating.

Following the application of the second coating layer 14, the second coating layer 14 is reduced in thickness with the progress of a drying process, and this causes the silicate compound flakes 20b and the aluminum flakes 20a to be aligned such that the major planes of the flakes 20 are aligned in parallel with the surface of the base member 10. At the same time, the flakes 20 are packed together. Thus, the major plane of each flake 20 extends substantially in parallel with the surface of the base member 10. The paint for the second coating layer 14 may contain a suitable additive to promote the aligning of the flakes 20 along the surface of the base member 10.

The advantages of the front grille 3 according to the embodiment of the present invention is discussed in the following. The lustrous coating 11 including the first coating layer 13 and the second coating layer 14 is applied on the front surface of the base member 10 of the emblem part 5. The second coating layer 14 contains silicate compound flakes 20b in addition to the aluminum flakes 20a. Therefore, the aluminum content of the second coating layer 14 can be made smaller than that of a conventional metallic paint without reducing the lustrous property thereof. As a result, millimeter waves can pass through the second coating layer 14 with a relatively small attenuation.

Since the aluminum flakes 20a and the silicate compound flakes 20b contained in the second coating layer 14 are oriented along the surface of the base member 10, the incident light from an orthogonal direction is reflected by the aluminum flakes 20a and the silicate compound flakes 20b contained in the second coating layer 14 in the same direction or in the direction orthogonal to the surface of the base member 10. The surface of the grille 3 (the molded component) demonstrates a high brightness when light is impinged on the surface of the grille 3 from the orthogonal direction owing to the presence of the aluminum flakes 20a and the silicate compound flakes 20b.

On the other hand, when the incident light is impinged upon the front surface of the grille 3 at an angle or obliquely, the light is reflected multiple times between the aluminum flakes 20a and the silicate compound flakes 20b contained in the second coating layer 14, and the reflected light is absorbed by the first coating layer 13. Therefore, the front surface of the grille 3 demonstrates a relatively low brightness when the light is obliquely applied to the surface of the grille 3. Thus, the surface of the grille 3 demonstrates highly contrasted brightness levels depending on the direction of the incident light, and highly contrasted highlight regions and shade regions are created on the surface of the grille 3 depending on the directions of the incident light. This creates a highly metallic appearance on the surface of the grille 3.

In order to further reduce the brightness of the shade regions, it is desirable that the first coating layer 13 demonstrates a low brightness when irradiated obliquely with respect to the surface of the base member 10, and has a high capability to absorb the light that is reflected multiple times. On the other hand, since both the silicate compound flakes 20b and the aluminum flakes 20a are whitish, if the first coating layer 13 on which the second coating layer 14 is applied is dark, the speckled appearance due to the presence of the aluminum flakes 20a and the silicate compound flakes 20b becomes pronounced.

In the present embodiment, since the brightness of the first coating layer 13 is 1 or higher, the speckled appearance in the second coating layer 14 due to the presence of the aluminum flakes 20a and the silicate compound flakes 20b is less noticeable as compared to the case where the brightness is lower than 1. Since the brightness of the first coating layer is 6 or lower, the surface of the grille 3 demonstrates a pearlescent white color so that a metallic appearance can be retained.

The average particle diameter of the aluminum flakes 20a was 10 μm in the present embodiment. By selecting the average particle diameter of the aluminum flakes 20a to be 1 μm or greater, as the paint dries, the aluminum flakes 20a are allowed to precipitate, and lay flat on the surface of the first coating layer 13 like tiles. By selecting the average particle diameter of the aluminum flakes 20a to be 30 μm or less, the aluminum flakes 20a are prevented from protruding out of the second coating layer 14. Therefore, the diffuse reflection of light that could be otherwise caused by the protrusion of the aluminum flakes 20a from the surface of the second coating layer 14 can be prevented.

Further, since synthetic mica has a tendency to peel off, the silicate compound flakes 20b can be easily prepared by peeling off the synthetic mica by grinding. By forming the silicate compound flakes 20b as flat plate pieces, the silicate compound flakes 20b can be easily disposed parallel to the surface of the base member 10. Moreover, by coating the silicate compound flakes 20b with titanium oxide, the luminance of the silicate compound flakes 20b can be improved, and the aesthetic appearance of the grille 3 can be improved.

The film thickness of the second coating layer 14 is selected to be 10 to 30 μm. By selecting the thickness of the second coating layer 14 to be 10 μm or more, the second coating layer 14 can be protected from deformation, discoloration, deterioration, and in particular can be given with a favorable weathering property. Since the thickness of the second coating layer 14 is selected to be 10 μm or more, the second coating layer 14 can be applied on the surface of the base member 10 uniformly. Further, by selecting the thickness of the second coating layer 14 to be 30 μm or less, when light is obliquely incident on the surface of the grille 3, the first coating layer 13 can effectively absorb the light that has been reflected by the aluminum flakes 20a and the silicate compound flakes 20b multiple times so that the brightness of shade regions can be reduced even further.

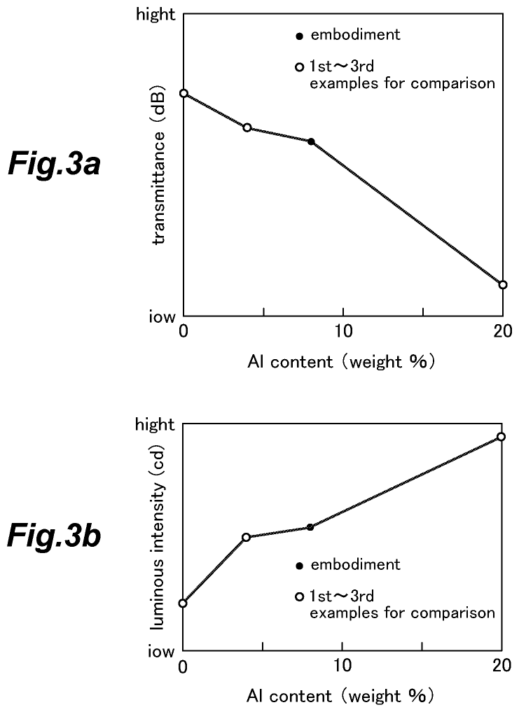

The significance of the aluminum content in the second coating layer 14 is discussed in the following by comparing the present embodiment with a first to third comparative example in which the aluminum content is varied. In the present embodiment, the paint for the first coating layer 13 was applied on the base member 10 having a thickness of 25 mm to form the first coating layer 13 having a thickness of 10 μm, and the paint for the second coating layer 14 was applied on the surface of the first coating layer 13 so as to form the second coating layer 14 having an aluminum content of 8 weight % and a thickness of 20 μm. The examples 1 to 3 for comparison were prepared in a similar manner except for the fact that the aluminum content was 0 weight %, 5 weight % and 20 weight %, respectively. The transmissivity values of millimeter wave through the sample according to the present embodiment, and the samples of examples 1 to 3 for comparison were measured by using a commercially available electromagnetic wave absorption ratio measurement system. More specifically, millimeter wave of 77 GHz was radiated onto the surface of each sample by placing a transmission antenna connected to a signal generator in front of the sample, and the intensity of the millimeter wave received by a reception antenna placed behind the sample was measured. The degrees of attenuation of the millimeter wave by the different samples were compared as shown in FIG. 3a. As shown in the graph of FIG. 3a, the degree of attenuation decreases with a decrease in the aluminum content.

The levels of luminous intensity of the samples were also measured by using a commercially available luminance color meter. The levels of luminous intensity are expressed by the IV (Intensity Value) (cd) which is greater in value with an increase in the brightness. As shown in FIG. 3b, the luminous intensity increases with an increase in the aluminum content.

As can be seen from the graph of FIG. 3a, the drop in the transmissivity when the aluminum content of the second coating layer 14 is increased from 10% to 20% (by weight) is sharper than when the aluminum content of the second coating layer 14 is increased from 0% to 10% (by weight). It is therefore desirable to select the aluminum content to be greater than 0% and less than or equal to 10% (by weight).

As can be seen from the graph of FIG. 3b, the luminous intensity sharply increases when the aluminum content of the second coating layer 14 is increased from 0% to 5% (by weight), and significantly less sharply increases when the aluminum content of the second coating layer 14 is increased from 5% to 20% (by weight).

Therefore, to obtain satisfactory levels of both the transmissivity and the luminous intensity, it is advantageous to select the aluminum content of the second coating layer 14 to be greater than 0% and less than or equal to 10% (by weight), and more preferably from 5% to 10% (by weight). In the illustrated embodiment the aluminum content was 8% by weight, and the emblem part 5 demonstrated an adequate luminosity, and an adequate transmissivity for millimeter wave.

The present invention has been described in terms of a concrete embodiment, but can be modified in various ways without departing from the spirit of the present invention. For instance, the silicate compound in the present embodiment consisted of synthetic mica, but may also be any phyllosilicates such naturally produced mica, glass or a mixture of these. The silicate compound that is used for the present invention may be transparent or white in color, but may also be tinted either naturally or artificially. For instance, the silicate compound may include tinted glass or mica or glass containing a small amount of metal oxides. Glass flakes can be prepared by crushing glass in thin plate form.

Also, the brightness of the first coating layer 13 was 1 in the foregoing embodiment, but may also be any value from 1 to 6. For instance, when the surface color of the base member 10 is silver with a brightness of 8, the brightness of the first coating layer 13 may be a value from 5 to 6.

1. A molded component for a vehicle, comprising:
a molded plastic base member;
a first coating layer applied on a surface of the base member; and
a second coating layer applied on a surface of the first coating layer and containing flakes of aluminum and flakes of a silicate compound;
the first coating layer having a brightness of 1 to 6.

2. The molded component according to claim 1, wherein the flakes of the silicate compound essentially consist of flakes of mica coated with titanium oxide, and/or flakes of glass coated with titanium oxide.

3. The molded component according to claim 1, wherein the second coating layer has a thickness of 10 μm to 30 μm and an aluminum content greater than 0% and less than or equal to 10% by weight.

4. The molded component according to claim 1, wherein an average particle diameter of the aluminum flakes is 1.0 μm to 30.0 μm.

5. The molded component according to claim 1, wherein the flakes of the silicate compound are oriented along the surface of the base member.
